(19) United States
(12) Patent Application Publication
(10) Pub. No.: US 2026/0086470 A1
(43) Pub. Date: Mar. 26, 2026

(54) POLYMER COAGULANTS FOR PREPARING EMULSION AGGREGATION TONER PARTICLES

(71) Applicant: XEROX CORPORATION, Norwalk, CT (US)

(72) Inventors: Genggeng QI, Webster, NY (US); Jordan A. FRANK, Rochester, NY (US); Chieh-Min CHENG, Rochester, NY (US)

(73) Assignee: XEROX CORPORATION, Norwalk, CT (US)

(21) Appl. No.: 18/893,555

(22) Filed: Sep. 23, 2024

(51) Int. Cl. G03G 9/093; G03G 9/08

(52) U.S. Cl. CPC G03G 9/09392; G03G 9/0804; G03G 9/081; G03G 9/0819; G03G 9/0827; G03G 9/09371

(57) ABSTRACT

Toner coagulation methods may comprise: providing an aqueous slurry comprising a plurality of polymer particles comprising a first polymer having a first ionic charge, a water-soluble organic polymer coagulant having a second ionic charge opposite to the first ionic charge; maintaining the aqueous slurry at a first temperature below the glass transition temperature (T_{g}) of the polymer particles until aggregated polymer particles having a desired aggregate size have formed; once aggregated polymer particles having the desired aggregate size have formed, heating the aqueous slurry at a second temperature above the T_{g}; maintaining the aqueous slurry above the T_{g} until the aggregated polymer particles have coalesced into molten toner particles having a desired shape and/or morphology; and once molten toner particles having the desired shape and/or morphology have formed, cooling the aqueous slurry at a third temperature below the T_{g} to form solidified toner particles.

### FIELD

The present disclosure relates generally to emulsion aggregation (EA) toner particles, and, more particularly, to methods for preparing EA toner particles using polymer coagulants.

### BACKGROUND

Emulsion aggregation (EA) toner is renowned for its exceptional printing quality due to precise morphology control and narrow particle size distributions that may be realized by emulsion aggregation and coalescence. During conventional emulsion-aggregation toner production methods, sub-micron latex polymer particles are aggregated into micron-sized aggregated particles using inorganic coagulants or small-molecule charged surfactants, followed by coalescence of the aggregated particles into a desired shape and size at elevated temperatures above the glass transition temperature (T_{g}) of the polymer. The choice of coagulant(s) may play a role in determining the extent of aggregation of the latex particles and ultimately influencing the yield and properties of the toner. Inorganic coagulants used for this purpose may include various metal salts, inorganic nanoparticles, and the like.

Although effective for promoting aggregation, metal salts and other inorganic coagulants may lead to elevated levels of residual metal ions in toner particles produced by emulsion aggregation and coalescence, which may adversely affect their rheological and optical properties for certain printing applications. Small-molecule surfactants may be similarly problematic as coagulants. For example, conventional emulsion aggregation toner particles often have less functional spreading and bonding properties, and dielectric properties may also be adversely affected. Removal of metal ions can increase costs and add complexity to toner production methods, and removal of metal ions may not be feasible in all cases. Furthermore, metal ions may cause decomposition and/or other interference with certain charge transfer agents, thereby limiting their effectiveness in toner production and printing. In the case of small-molecule surfactants, relatively large amounts may be needed to promote aggregation of the toner particles, and surfactant leeching may become problematic following printing.

Accordingly, alternative coagulation processes are needed to address these concerns.

### SUMMARY

In various embodiments, methods of preparing emulsion aggregation toners are provided herein. The methods comprise: providing an aqueous slurry comprising a plurality of polymer particles comprising a first polymer having a first ionic charge, a water-soluble organic polymer coagulant having a second ionic charge opposite to the first ionic charge, and optionally, one or more internal additives; maintaining the aqueous slurry at a first temperature below the glass transition temperature (T_{g}) of the polymer particles until aggregated polymer particles having a desired aggregate size have formed; once aggregated polymer particles having the desired aggregate size have formed, heating the aqueous slurry at a second temperature above the T_{g}; maintaining the aqueous slurry above the T_{g} until the aggregated polymer particles have coalesced into molten toner particles having a desired shape and/or morphology; and once molten toner particles having the desired shape and/or morphology have formed, cooling the aqueous slurry at a third temperature below the T_{g} to form solidified toner particles.

In other various embodiments, the present disclosure provides toner compositions. The toner compositions comprise: toner particles comprising one or more first polymers having a first ionic charge, and optionally, one or more internal additives within the toner particles; and optionally, one or more external additives blended with the toner particles; wherein the toner particles are substantially free of a metal salt coagulant, an inorganic coating, inorganic nanoparticles, a chelating agent, or any combination thereof.

### BRIEF DESCRIPTION OF THE DRAWINGS

The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is an SEM image of EA toner particles synthesized using water-soluble organic polymer coagulant 1 (Example 3).

FIG. 2 is an SEM image of EA toner particles synthesized using water-soluble organic polymer coagulant 2 (Example 4).

FIG. 3 is an SEM image of EA toner particles synthesized using a metal salt coagulant (Comparative Example 1).

### DETAILED DESCRIPTION

The present disclosure relates generally to emulsion aggregation (EA) toner particles, and more particularly, to methods for preparing EA toner particles using polymer coagulants.

The present disclosure provides methods for preparing EA toner particles and EA toner particle compositions resulting from the same. Such methods comprise preparing EA toner particles via an emulsion-aggregation process, in which polymer particles comprising a first polymer having a first ionic charge are aggregated using a water-soluble organic polymer coagulant having a second ionic charge opposite to the first ionic charge, followed by heating the resulting aggregated polymer particles to promote coalescence of the aggregated polymer particles into a desired shape and/or morphology. The resulting molten toner particles are subsequently cooled to form solidified toner particles, which may then be recovered and blended with various external additives, if desired, to form a toner composition. Additional details concerning the foregoing are provided hereinbelow.

By rationally designing the water-soluble organic polymer coagulant to have an ionic charge opposite that of the first polymer (or a polymer coating disposed upon aggregated polymer particles before coalescence), the present disclosure may afford EA toner particles comparable to those obtained using small-molecule surfactants and/or metal salts as coagulants. Advantageously, such methods may eliminate the need for metal ion removal following toner production, such as by the addition of chelating agents or by performing extensive washing operations, thereby streamlining production and reducing process cost and complexity. An added advantage of this approach is that relatively low amounts of water-soluble organic polymer coagulants may be effective to promote aggregation of polymer particles prior to consolidation. As such, the methods described herein may effectively reduce or eliminate metal ion residue in EA toner particles without using chelating agents, which may also be present as a residue in the EA toner particles, while minimizing any adverse effects on the toner production method itself.

Accordingly, toner particles and methods for producing toner particles according to the present disclosure may exclude metal salt coagulants, chelating agents, inorganic nanoparticle coagulating agents, and similar materials. Surfactant-based coagulating agents may be excluded in some cases as well. Typical coagulating agents excluded from methods of the present disclosure and the toner particles resulting therefrom may include, for example, divalent or multivalent salts such as, polyaluminum halides such as polyaluminum chloride (PAC), or the corresponding bromide, fluoride, or iodide salts, polyaluminum silicates such as polyaluminum sulfosilicate (PASS), and water-soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper (II) chloride, copper (II) sulfate, and any combination thereof. Chelating agents used to remove metal ions from the toner particles may be similarly excluded in the methods and resulting toner particles of the present disclosure.

Aspects of the present disclosure are further compatible with additional additives that may be present in toner compositions containing the EA toner particles. The additives may be internal or external. “Internal additives” may be present during the emulsion-aggregation process and become incorporated within the interior of the toner particles. “External additives,” in contrast, may be blended with the toner particles after formation or isolation thereof, such that the external additives are located on the exterior (outer surface) of the toner particles or in the interstitial space between toner particles. Additives that may be present include, but are not limited to, colorants, waxes, charge transfer agents, and other common materials present in EA toner particles. The exclusion of metal salt coagulants according to the description herein may be especially advantageous for facilitating incorporation of charge transfer agents into the EA toner particles and EA toner compositions, which may otherwise be degraded in the presence of certain metal ions.

In the present disclosure, the glass transition temperature may be determined by differential scanning calorimetry over a temperature range of 0-140° C. with a 3° C./minute ramping rate. The temperature is also modulated +/−0.48° C. every 60 seconds.

In the present disclosure, the term “D50” refers to a diameter at which 50% of a sample (on a volume basis unless otherwise specified) is comprised of particles having a diameter less than said diameter value. D50 represents the average particle size by volume. For example, the average particle size may be measured by means of an instrument utilizing the Coulter Principle (i.e., the ESZ (Electrical Sensing Zone) method), such as a Beckman Coulter Multisizer 3, operated in accordance with the manufacturer's instructions.

In the present disclosure, the terms “circularity” and “sphericity” relative to toner particles refer to how close the toner particles are to a perfect sphere. To determine circularity, optical microscopy images are taken of the particle. The perimeter (P) and area (A) of the particle in the plane of the microscopy image is calculated (e.g., using a SYSMEX FPIA 3000 particle shape and particle size analyzer, available from Malvern Instruments). The circularity of the toner particle is C_{EA}/P, where C_{EA} is the circumference of a circle having the area equivalent to the area (A) of the actual particle. The more spherical the toner particles are, the closer the circularity is to 1.

Methods of the present disclosure may comprise: providing an aqueous slurry comprising a plurality of polymer particles comprising a first polymer having a first ionic charge, a water-soluble organic polymer coagulant having a second ionic charge opposite to the first ionic charge, and optionally, one or more internal additives; maintaining the aqueous slurry at a first temperature below the glass transition temperature (T_{g}) of the polymer particles until aggregated polymer particles having a desired aggregate size have formed; once aggregated polymer particles having the desired aggregate size have formed, heating the aqueous slurry at a second temperature above the T_{g}; maintaining the aqueous slurry above the T_{g} until the aggregated polymer particles have coalesced into molten toner particles having a desired shape and/or morphology; and once molten toner particles having the desired shape and/or morphology have formed, cooling the aqueous slurry at a third temperature below the T_{g} to form solidified toner particles. The second temperature above the T_{g} may be above or below the melting point or softening temperature of the polymer particles.

The methods for preparing EA toner particles according to the description herein may be similar to those performed conventionally when forming toner particles, except for being modified to utilize a water-soluble polymer coagulant for promoting aggregation of polymer particles during the aggregation stage. Examples of emulsion-aggregation toner particle production methods that may be suitably modified by utilizing a water-soluble polymer coagulant according to the description herein may include, for instance, those described in U.S. Pat. Nos. 5,364,729, 5,496,676, 5,501,935, 5,919,595, 6,132,924, 6,495,302, 6,268,102, 6,500,597, and 6,416,920, the disclosures of each of which are hereby incorporated by reference in their entirety.

Aqueous slurries of the present disclosure may comprise emulsions (i.e., latexes) or dispersions of a plurality of suitable polymer particles in an aqueous carrier fluid. The aqueous slurries may comprise various quantities of the polymer particles, such as a polymer particle loading of about 10 wt % to about 50 wt % polymer particle solids, based on total mass of the aqueous slurry, including all wt % values and subranges in between, such as about 15 wt % to about 40 wt %, or about 20 wt % to about 35 wt %.

In various embodiments, providing an aqueous slurry may comprise preparing and/or dispersing the plurality of polymer particles within the aqueous slurry. An aqueous polymer emulsion may be obtained commercially or prepared through an appropriate polymerization technique, such as emulsion polymerization. The polymer particles may comprise one or more first polymers of various types. The first polymer may comprise one or more monomers having the first ionic charge and optionally one or more additional monomers that are uncharged. Functional groups providing the first ionic charge may be the same or different.

Polymer particles suitable for use in the disclosure herein may have any particle size and/or particle size distribution that is effective to undergo aggregation and subsequent consolidation. In non-limiting examples, the D50 of the polymer particles within the aqueous slurry may range, for example, from about 1 μm to about 10 μm and all values and subranges in between, such as about 3 μm to about 10 μm, or about 4 μm to about 9 μm, or about 6 μm to about 8 μm. In some examples, polymer particles having an average particle size of about 1 μm or below or about 500 nm or below may also be suitably used.

In some embodiments, providing an aqueous slurry may further comprise polymerizing one or more monomers to form the polymer particles using any suitable polymerization technique. Suitable polymerization techniques may include, for example, emulsion polymerization, dispersion polymerization, suspension polymerization, precipitation polymerization, or the like. The resulting polymerization product may comprise a latex or a dispersion of the polymer particles.

Suitable polymers for forming the toner particles may include but are not limited to polyacrylates, polyesters, polystyrenes, any copolymer thereof, and any combination thereof. Suitable polyesters may be linear, branched, or combinations thereof. Illustrative polyesters that may be suitable include those described in U.S. Pat. No. 11,092,906, the disclosure of which is incorporated by reference in its entirety. In some embodiments, the first polymer may comprise an anionic polyester.

One, two, or even more polymers may be present in the polymer particles and subsequently within the toner particles formed therefrom. When two or more first polymers are present in the polymer particles, the polymers may differ in at least one aspect (e.g., composition, molar ratio of co-monomers, molecular weight, and the like) and be in any suitable ratio on a mass basis such as, for instance, about 1% (first polymer):99% (second polymer) to about 99% (first polymer):1% (second polymer), or about 10% (first polymer):90% (second polymer) to about 90% (first polymer):10% (second polymer).

Suitable water-soluble organic polymer coagulants may comprise a plurality of one or more ionic groups, such that the water-soluble organic polymer coagulants have a second ionic charge opposite to the first ionic charge of polymer particles. Water-soluble organic polymer coagulants may comprise a plurality of cationic groups, when the plurality of polymer particles comprise a plurality of anionic groups, and vice versa. Suitable cationic groups (e.g., within the water-soluble organic polymer coagulant) may include, but are not limited to, ammonium groups, amine groups, phosphonium groups, and the like. Suitable anionic groups (e.g., within the polymer particles) may include, but are not limited to, carboxylic acid groups, sulfonic acid groups, phosphonic acid groups, and the like. For example, in various aspects, the polymer particles may comprise an anionic polymer (e.g., an anionic polyester) and the water-soluble organic polymer coagulant may comprise a cationic polymer.

In addition to the plurality of ionic groups, the water-soluble organic polymer coagulants may further comprise one or more nonionic groups, such as when the water-soluble organic polymer coagulants comprise one or more monomers having the first ionic charge and further one or more nonionic monomers. Suitable nonionic monomers may include moieties such as, but not limited to, hydroxyl groups, hydroxyalkyl groups, alkoxylate groups, alkyl groups, aromatic groups, or the like. The one or more monomers having the first ionic charge may be present in a greater molar amount than the one or more nonionic monomers. In non-limiting examples, a mole ratio of the one or more monomers having the first ionic charge to the one or more nonionic monomers may range from about 1:1 to about 25:1, including all values and subranges in between, such as about 2:1 to about 25:1, or about 2:1 to about 15:1, or about 5:1 to about 25:1, or about 2:1 to about 10:1, or about 10:1 to about 25:1.

Suitable water-soluble organic polymer coagulants may comprise natural polymers, synthetic polymers, or any combination thereof. Natural polymer coagulants may include, but are not limited to, chitosan, alginates, other charged biopolymers, or any combination thereof. Synthetic polymer coagulants may have a vinyl polymer backbone and include, but are not limited to, acrylate or methacrylate polymers and copolymers. Other suitable synthetic polymer coagulants may include, for example, polydiallyldimethyl ammonium chloride (polyDADMAC), polyamines, polyethyleneimine, polyquats, the like, or any combination thereof.

The water-soluble organic polymer coagulants may be prepared by any suitable polymerization process, such as, but not limited to, free radical solution polymerization, or the like. The water-soluble organic polymer coagulant may be provided neat or as an aqueous solution, which is then combined with the polymer particles in the aqueous slurry. Alternately, the water-soluble organic polymer coagulant may be formed in situ in the aqueous slurry.

The water-soluble organic polymer coagulant may be metered into the aqueous slurry over time. For example, the water-soluble organic polymer coagulant may be metered into the aqueous slurry over a period of about 5 minutes to about 240 minutes, including all values and subranges in between, such as about 30 minutes to about 200 minutes, or about 10 minutes to about 60 minutes, although more or less time may be used as desired or required.

A sufficient amount of the water-soluble organic polymer coagulant may be present in the aqueous slurry to promote aggregation of the polymer particles. The water-soluble organic polymer coagulant may be present in the aqueous slurry in an amount of, for example, about 0.05 wt % to about 0.2 wt %, or about 0.1 wt % to about 1 wt %, or about 0.2 wt % to about 0.8 wt %, based on the mass of isolated toner particles, including all wt % values and subranges in between, such as about 0.2 wt % to about 0.5 wt %, or about 0.2 wt % to about 0.7 wt %, or about 0.25 wt % to about 0.5 wt %, or about 0.35 wt % to about 0.75 wt %, or about 0.4 wt % to about 0.7 wt %. The mass of the isolated toner particles may be measured directly by weighing the toner particles following production thereof or determined indirectly by presuming that all solids introduced into the emulsion-aggregation process become incorporated in the toner particles.

Optionally but preferably, the aqueous slurry may comprise one or more internal additives, which may be dissolved, dispersed, or emulsified therein. Illustrative internal additives that may be present include but not limited to, surfactants, colorants, waxes, charge transfer agents, or the like, of the present disclosure. One having ordinary skill in the art will recognize illustrative types of such internal additives and suitable amounts to include during an emulsion aggregation toner production method.

During or prior to aggregation, the aqueous slurry may be maintained at an acidic pH value. A suitable acidic pH value may be reached or maintained by adding an acid to the aqueous slurry such as, for example, acetic acid, nitric acid or the like. In non-limiting examples, the aqueous slurry may be adjusted to an acidic pH value of about 2 to about 4.5, including all pH values and subranges in between, such as about 2 to about 4, or about 2 to about 3.5, or about 2 to about 3, or about 3 to about 4.5, or about 3 to about 4, or about 3 to about 3.5, or about 3.5 to about 4.5, or about 3.5 to about 4, or about 4 to about 4.5.

The aqueous slurry may be maintained at the first temperature below the glass transition temperature for a suitable time until aggregated polymer particles having a desired aggregate size have formed. The aqueous slurry may be stirred while aggregating the polymer particles at the first temperature. The suitable time may range from about 10 minutes to about 24 hours, for example, including all values and subranges in between, such as about 30 minutes to about 2 hours, or about 1 hour to about 8 hours, or about 3 hours to about 12 hours. The desired aggregate size may range, for example, from about 3 μm to about 10 μm, or about 4 μm to about 9 μm, or about 6 μm to about 8 μm, or about or about 5 μm to about 6 μm, or about 6 μm to about 7 μm, or about 6 μm to about 6.5 μm. Sampling may be conducted during the aggregation process using any suitable technique and apparatus.

In some examples, a second polymer may be combined with the aqueous slurry once the aggregated polymer particles having the desired aggregate size have formed, such that the second polymer forms a shell upon the aggregated polymer particles. The second polymer may be the same as or different than the first polymer, and if different, the second polymer may or may not bear an ionic charge. Preferably, the second polymer is the same as the first polymer and/or bears the same ionic charge of the first polymer. Core-shell toner particles may result from the foregoing, wherein the core-shell toner particles comprise a core comprising the at least one first polymer and a shell comprising the second polymer.

During aggregation, the aqueous slurry may be maintained below the glass transition temperature of the polymer particles until aggregated polymer particles having a desired aggregate size have formed. Once aggregated polymer particles having the desired aggregate size have formed, the aqueous slurry may be heated at a second temperature above the glass transition temperature, which may be above or below the melting point or softening temperature of the first polymer. Heating the aggregated polymer particles above the glass transition temperature may promote coalescence of the polymer particles with one another, wherein coalescence takes place with the toner particles in molten form. Coalescence above the glass transition temperature (e.g., at the second temperature or a range of temperatures encompassing the second temperature) may be maintained until the molten toner particles have a desired shape and/or morphology, as described further below. Aggregation and coalescence may take place as discrete steps in the methods disclosed herein.

Aggregation may be halted by increasing the pH of the aqueous slurry (e.g., once a desired aggregate size has been reached). In various examples, an alkaline pH value may be established or maintained in the aqueous slurry prior to or while heating the aqueous slurry at the second temperature. Suitable alkaline pH values may include pH values of about 7.1 to about 10, including all values and subranges in between, such as about 7.1 to about 9, or about 7.5 to about 8.5. The pH of the aqueous slurry may be adjusted with a suitable base, such as, but not limited to, ammonium hydroxide, organic amines, alkali metal carbonates or bicarbonates, or alkali metal hydroxides, such as, for example, sodium hydroxide, potassium hydroxide, and any combination thereof. More specific examples of suitable bases may be found in U.S. Pat. No. 10,907,016, which is incorporated herein by reference. The alkaline pH may be maintained or further modified while heating the aqueous slurry at the second temperature.

Optionally, an aqueous acid may be added to the aqueous slurry during coalescence to increase the rate of coalescence. If an aqueous acid is added, the pH of the aqueous slurry may remain at an alkaline pH value or reach neutrality.

Coalescence may take place at a temperature above the glass transition temperature of the first polymer, while holding the aqueous slurry at the second temperature above the glass transition temperature for a sufficient time until a desired shape and/or morphology is reached. Stirring or similar agitation may be maintained during coalescence. The second temperature may be a temperature above the glass transition temperature of the polymer particles but below the melting point of the polymer particles to prevent plasticization. In the case of the polymer particles comprising a polyester, for example, the second temperature may range from about 60° C. to about 100° C., including all values and subranges in between, such as about 65° C. to about 85° C., or about 75° C. to about 85° C. Higher or lower temperatures may be used, depending upon the type of first polymer that is present.

Coalescence may proceed over a time of about 5 minutes to about 9 hours, including all values and subranges in between, such as 0.5 hours to about 4 hours, or about 1 hour to about 6 hours. During or near the end of coalescence, the pH value of the mixture may be decreased to accelerate the rate of coalescence, as discussed above, such as by adding an acid, such as acetic acid, nitric acid, or the like.

In some examples, coalescence may proceed until the molten toner particles have reached a desired circularity, as described herein. The circularity of the molten toner particles may be at least about 0.95, or at least about 0.96, or at least about 0.97, or at least about 0.98, or at least about 0.99 in particular examples. Sampling may be conducted during the coalescence process using any suitable technique and apparatus to determine the circularity.

Once coalescence has taken place and molten toner particles having the desired shape and/or morphology have been formed, the aqueous slurry may be cooled to a third temperature below the glass transition temperature to form solidified toner particles. The third temperature may be the same as or different than the first temperature. By cooling below the glass transition temperature, the molten toner particles may harden into their final size, shape and/or morphology. The third temperature may be room temperature, such as from about 20° C. to about 25° C., for example, but higher or lower temperatures below the glass transition temperature may also be appropriate. Cooling may be rapid or slow, as desired. Suitable cooling methods may include, for example, introducing cold water to a jacket around a reactor containing the aqueous slurry or passing the aqueous slurry through a heat exchanger.

Following cooling, the solidified toner particles may be further processed, such as collection of the solidified toner particles (e.g., by filtration and/or centrifugation), blending of the solidified toner particles with one or more external additives, and the like. In some examples, the aqueous slurry may be filtered to collect the solidified toner particles, which may then be further washed with water and dried. Drying may be accomplished by any suitable method for drying including, for example, freeze-drying, vacuum drying, heated air drying, or the like.

The solidified toner particles obtained by the methods described herein may be of any suitable shape, size, and morphology. Preferably, the toner particles may have a circularity, as determined by particle imaging, e.g., using a FPIA Sysmex3000, of about 0.98 to 1.00, including all values and subranges in between, such as about 0.98 to about 0.99. Preferably, the toner particles may have a (D50), as determined by the Coulter Principle, e.g., using a Beckman Coulter Multisizer 3, of about 5 microns to about 8 microns, including all values and subranges in between, such as about 6 microns to about 7 microns. Further, the toner particles may have various degrees of smoothness, as characterized by surface area, which may be measured by well-known BET methods (either the single-point BET method or the multi-point BET method). For example, BET surface area may be measured using a Micromeritics Tristar instrument or similar instrument according to ASTM C1274, with flow-through degassing instead of vacuum degassing. In non-limiting examples, the toner particles of the present disclosure may have a single-point BET surface area of about 0.6 m²/g to about 0.9 m²/g, including all values and subranges in between, such as about 0.65 m²/g to about 0.85 m²/g and/or a multi-point BET surface area of about 0.7 m²/g to about 1 m²/g, including all values and subranges in between, such as about 0.75 m²/g to about 0.95 m²/g.

In some examples, the EA toner particles of the present disclosure may comprise a first polymer that is a polyester. Suitable polyesters may have various polymer molecular weights and distributions thereof, as determined, for example, by gel permeation chromatography (GPC). In various embodiments, EA toner particles may have a number average molecular weight (Mₙ) of from about 4000 grams per mole (g/mol) to about 6000 g/mol, including all values and subranges in between, such as about 4500 g/mol to about 5500 g/mol. In various embodiments, EA toner particles may have a weight average molecular weight (M_{w}) of about 20,000 grams per mole (g/mol) to about 40,000 g/mol, including all values and subranges in between, such as about 25,000 g/mol to about 35,000 g/mol. In various embodiments, EA toner particles may have a molecular weight distribution (Mₙ/M_{w}) of about 4 to about 8, including values and subranges in between, such as about 5 to about 7.

Suitable polyesters may also exhibit various thermal transitions, determined, for example, using differential scanning calorimetry (DSC). In various embodiments, EA toner particles may have a glass transition temperature (T_{g}) of about 50° C. to about 60° C., including all values and subranges in between, such as about 50° C. to about 55° C. In various embodiments, EA toner particles of the present disclosure may have a melt temperature (Tₘ) of about 60° C. to about 100° C., including values and subranges in between, such as about 70° C. to about 90° C.

Suitable polyesters may also exhibit various rheological properties, as determined by a rotational rheometer (e.g., an ARES-G2 rheometer) or a capillary flow rheometer. In various embodiments, EA toner particles of the present disclosure may have a storage modulus (G′), which decreases when the temperature is increased from 120° C. to 140° C., such as a decrease of about 40% to about 80%, including all values and subranges in between, such as a decrease of about 50% to about 70%. In various aspects, EA toner particles may have a loss modulus (G″) which decreases, when the temperature is increased from 120° C. to 140° C., such as a decrease of about 50% to about 90%, including all values and subranges in between, such as a decrease of about 60% to about 80%.

Once toner particles are isolated from a toner production method, the toner particles may be further processed into toner compositions. Toner compositions may comprise the toner particles (optionally, including one or more internal additives within the toner particles), and optionally, one or more external additives blended with the toner particles. Any of the toner particles described herein may be used to form a toner composition. As described herein, the toner particles are substantially free of a metal salt coagulant, an inorganic coating, inorganic nanoparticles, a chelating agent, or any combination thereof. The term “substantially free of” means that overall or individually, about 1% or less of a given component or mixture of specified components is present, based on total mass of the toner particles. Preferably, toner particles that are “substantially free of” the indicated component(s) have about 0.5 wt % or less or about 0.1 wt % or less of a given component or components.

In some embodiments, the water-soluble organic polymer coagulant may be present in the toner particles, typically as an internal additive.

One or more surfactants may be present in combination with the polymer particles prior to and/or after formation of the aqueous slurry thereof, such as during polymerization, during formation of the aqueous slurry, or combinations thereof. Such surfactants may be present within the toner particles, typically as an internal additive, after aggregation takes place. Such surfactants may comprise a single surfactant or two or more surfactants. In various embodiments, the emulsion aggregation process may exclude any addition of further surfactants, such as small-molecule surfactants to promote coagulation of polymer particles.

One or more surfactants may optionally be combined with the toner particles when forming a toner composition, in which case the one or more surfactants may be present as an external additive.

Dyes, pigments, similar colorants, and mixtures thereof may be present in the aqueous slurry from which the toner particles are formed. As such, dyes, pigments, and similar colorants may be present as internal additives within the toner particles. Colorants may comprise a single colorant or two or more colorants. The dyes, pigments, or colorants may be present in the toner particles at about 0.1 wt % to about 35 wt %, or about 1 wt % to about 15 wt %, or about 3 wt % to about 10 wt % of the toner particles, based on total mass of the toner particles. Suitable dyes, pigments, and similar colorants will be familiar to one having ordinary skill in the art and may be selected accordingly.

Waxes may be present in the aqueous slurry from which the toner particles are formed. Waxes may comprise a single wax or two or more waxes. A single or multiple waxes may be added, for example, to adjust characteristics of the toner particles, such as shape, size, surface area, charging and/or fusing characteristics, gloss, stripping, offset properties, the like, or combinations thereof. When included, the wax may be present in an amount of, for example, about 1 wt % to about 20 wt %, including all values and subranges in between, based on total mass of the toner particles. Suitable waxes and amounts thereof will be familiar to one having ordinary skill in the art and may be selected accordingly.

Charge transfer agents may be present in the aqueous slurry from which the toner particles are formed. Charge transfer agents may comprise a single charge transfer agent or two or more charge transfer agents. The charge transfer agent may include positive or negative charge transfer agents. Charge transfer agents may be included in EA toners, for example, in an amount of about 0.01 wt % to about 3 wt %, including all values and subranges in between, based on total weight of the toner particles. Suitable charge transfer agents and amounts thereof will be familiar to one having ordinary skill in the art and may be selected accordingly.

External additives may also be included in the toner compositions. Suitable external additives may include, for example, flow aids, spacers, charge regulators, and the like. Examples of the foregoing will be familiar to persons having ordinary skill in the art. When present, external additives may be present in an amount of about 0.1 wt % to about 10 wt %, including all values and subranges in between, by total mass of the EA toner.

It is envisioned that the toner particles and toner compositions of the present disclosure may be used in any suitable procedure for forming an image with a toner, including in applications taking place by xerographic printing and printing processes other than xerographic printing.

Embodiments disclosed herein include:

Embodiment 1. A method comprising:
providing an aqueous slurry comprising a plurality of polymer particles comprising a first polymer having a first ionic charge, a water-soluble organic polymer coagulant having a second ionic charge opposite to the first ionic charge, and optionally, one or more internal additives;
maintaining the aqueous slurry at a first temperature below the glass transition temperature (T_{g}) of the polymer particles until aggregated polymer particles having a desired aggregate size have formed;
once aggregated polymer particles having the desired aggregate size have formed, heating the aqueous slurry at a second temperature above the T_{g};
maintaining the aqueous slurry above the T_{g} until the aggregated polymer particles have coalesced into molten toner particles having a desired shape and/or morphology; and
once molten toner particles having the desired shape and/or morphology have formed, cooling the aqueous slurry at a third temperature below the T_{g} to form solidified toner particles.

Embodiment 2. The method of Embodiment 1, further comprising:
combining a second polymer with the aqueous slurry once the aggregated polymer particles having the desired aggregate size have formed, the second polymer forming a shell upon the aggregated polymer particles.

Embodiment 3. The method of Embodiment 1 or Embodiment 2, further comprising:
establishing an alkaline pH value in the aqueous slurry prior to or while heating the aqueous slurry at the second temperature.

Embodiment 4. The method of Embodiment 3, wherein the alkaline pH value is maintained while maintaining the aqueous slurry above the T_{g}.

Embodiment 5. The method of Embodiment 3 or Embodiment 4, further comprising:
adding an aqueous acid to the aqueous slurry while maintaining the aqueous slurry above the T_{g} to lower pH while still maintaining an alkaline pH value.

Embodiment 6. The method of any one of Embodiments 1-5, wherein the polymer particles comprise at least one first polymer selected from the group consisting of polyesters, polystyrenes, polyacrylates, any copolymer thereof, and any combination thereof.

Embodiment 7. The method of any one of Embodiments 1-6, wherein the water-soluble organic polymer coagulant comprises an acrylate or methacrylate polymer or copolymer.

Embodiment 8. The method of any one of Embodiments 1-7, wherein the water-soluble organic polymer coagulant has a positive charge and the polymer particles have a negative charge.

Embodiment 9. The method of any one of Embodiments 1-8, wherein the water-soluble organic polymer coagulant comprises one or more monomers having the first ionic charge and one or more nonionic monomers.

Embodiment 10. The method of Embodiment 9, wherein the one or more monomers having the first ionic charge is present in a greater molar amount than the one or more nonionic monomers.

Embodiment 11. The method of any one of Embodiments 1-10, wherein a metal salt coagulant and/or a chelating agent are not present when forming the aggregated polymer particles.

Embodiment 12. The method of any one of Embodiments 1-11, wherein the aqueous slurry comprises about 0.1 wt % to about 1 wt % of the water-soluble organic polymer coagulant, based on total mass of the solidified toner particles.

Embodiment 13. The method of any one of Embodiments 1-12, wherein the one or more internal additives are present and comprise at least one additive selected from the group consisting of colorants, waxes, charge transfer agents, and any combination thereof.

Embodiment 14. The method of any one of Embodiments 1-13, further comprising:
isolating the solidified toner particles; and
optionally, blending one or more external additives with the solidified toner particles.

Embodiment 15. A toner composition comprising:
toner particles comprising one or more first polymers having a first ionic charge, and optionally, one or more internal additives within the toner particles; and
optionally, one or more external additives blended with the toner particles;
   wherein the toner particles are substantially free of a metal salt coagulant, an inorganic coating, inorganic nanoparticles, a chelating agent, or any combination thereof.

Embodiment 16. The toner composition of Embodiment 15, wherein the toner particles further comprise a water-soluble organic polymer coagulant having a second ionic charge opposite to the first ionic charge.

Embodiment 17. The toner composition of Embodiment 15 or Embodiment 16, wherein the toner particles comprise at least one first polymer selected from the group consisting of polyesters, polystyrenes, polyacrylates, any copolymer thereof, and any combination thereof.

Embodiment 18. The toner composition of any one of Embodiments 15-17, wherein the one or more internal additives and/or the one or more external additives, if present, comprise at least one additive selected from the group consisting of colorants, waxes, charge transfer agents, and any combination thereof.

Embodiment 19. The toner composition of any one of Embodiments 15-18, wherein the toner particles comprise core-shell toner particles, the core-shell toner particles comprising a core comprising the at least one first polymer and a shell comprising a second polymer.

Embodiment 20. The toner composition of any one of Embodiments 15-19, wherein the toner particles have a D50 of about 5 μm to about 8 μm, a circularity of about 0.98 to about 1.00, and/or a surface area of about 0.6 m²/g to about 1.0 m²/g.

To facilitate a better understanding of the present disclosure, the following examples of preferred or representative embodiments are given. In no way should the following examples be read to limit, or to define, the scope of the invention.

### EXAMPLES

D50 by volume was characterized using a Coulter Multisizer-3 instrument, and the circularity was quantified using an FPIA Sysmex3000 instrument. Glass transition temperature (T_{g}) was determined employing differential scanning calorimetry (DSC) over a temperature range of 0-140° C. with a 3° C./minute ramping rate. The temperature was also modulated +/−0.48° C. every 60 seconds. G′ and G″ were determined at 120° C. and/or 140° C. using an ARES-G2 rheometer. Tₛ (softening temperature), T_{fb} (flow-beginning temperature), and T_{1/2} (half-temperature of analysis method) were determined by capillary flow rheometry. Metal ion levels of the toner particles were determined by Inductively Coupled Plasma Atomic Emission Spectroscopy (ICP-AES).

Example 1—Polymer Synthesis: Synthesis of water-soluble organic polymer coagulant 1. 40 g of [2-(methacryloyloxy)ethyl]trimethylammonium chloride (75 wt % in water), 0.5 g of 2-mercaptoethanol, and 1.6 g of 2,2′-azobis(2-methylpropionamidine) dihydrochloride were dissolved in 100 g of deionized (DI) water. The resultant solution was purged with nitrogen (N₂) for 10 minutes, heated at 80° C., and then maintained at that temperature for 12 hours to produce a solution of water-soluble organic polymer coagulant 1. Water-soluble organic polymer coagulant 1 is a cationic polymer.

Example 2—Polymer Synthesis: Synthesis of water-soluble organic polymer coagulant 2. 40 g of [2-(methacryloyloxy)ethyl]trimethylammonium chloride (75% in water), 10 g of 2-hydroxyethyl methacrylate, 0.5 g of 2-mercaptoethanol, and 1.6 g of 2,2′-azobis(2-methylpropionamidine) dihydrochloride were dissolved in 100 g of DI water. The resultant solution was purged with N₂ for 10 minutes heated at 80° C., and then maintained at that temperature for 12 hours to produce a solution of water-soluble organic polymer coagulant 2. Water-soluble organic polymer coagulant 2 is a cationic polymer.

Example 3—Toner Synthesis: Toner synthesis using water-soluble organic polymer coagulant 1. Toner particles were prepared using an emulsion aggregation-coalescence process as follows. Core polyester latex, pigment, waxes, and DI water were mixed in a reactor. The pH was adjusted to 3.5 using aqueous nitric acid solution, and 0.45 parts per hundred (pph) (based on the final mass of the toner particles, assuming full incorporation of the core polyester, pigment, and wax into the final toner particles) of organic polymer coagulant 1 solution (Example 1) was added and the obtained slurry was homogenized. The mixture was heated at 46-48° C. for aggregation. Particle size (D50) was monitored, and at a D50 of about 5 microns (μm), a negatively-charged polyester shell latex was added to the mixture using a metered pump until a D50 of about 6.3 μm was reached. The aggregation step was quenched by addition of aqueous sodium hydroxide solution to increase the pH to about 8.3. The mixture was then heated at 75° C. for coalescence. Aqueous sodium hydroxide solution was slowly added to the slurry during ramp-up to the coalescence temperature to maintain the pH at ˜8.3. The mixture was held at the coalescence temperature and the circularity was monitored. The pH was further lowered by the addition of an acid, such as aqueous nitric acid solution, to increase the rate of coalescence, if needed. Once a circularity of about 0.98 was achieved, the mixture was passed through a heat exchanger to quickly lower the temperature below the T_{g} of the toner. The toner particles were collected by filtration, washed, and dried using typical methods. Following isolation of the toner particles, the D50 was 6.40 μm, the circularity was 0.981, and the T_{g} (mid) was 51.4° C. Rheological properties were as follows: G′=1358 Pa and G″=2815 Pa at 120° C.; and G′=452 Pa and G″=630 Pa at 140° C.

Example 4—Toner Synthesis: Toner synthesis using water-soluble organic polymer coagulant 2. Toner particles were prepared using an emulsion aggregation-coalescence process as follows. Core polyester latex, pigment, waxes, and deionized water were mixed in a reactor. The pH was adjusted to 3.5 using aqueous nitric acid solution, and 0.5 pph (based on the final mass of the toner particles, assuming full incorporation of the core polyester, pigment, and wax into the final toner particles) of organic polymer coagulant 2 solution (Example 2) was added and the obtained slurry was homogenized. The mixture was heated at 46-48° C. for aggregation. Particle size (D50) was monitored, and at a D50 of about 5 μm, a negatively-charged polyester shell latex was added to the mixture using a metered pump until a D50 of about 6.3 μm was reached. The aggregation step was quenched by addition of aqueous sodium hydroxide solution to increase the pH to about 8.3. The mixture was then heated at 75° C. for coalescence. Aqueous sodium hydroxide solution was slowly added to the slurry during ramp-up to the coalescence temperature to maintain the pH at ˜8.3. The mixture was held at the coalescence temperature and the circularity was monitored. The pH was further lowered by the addition of an acid, such as aqueous nitric acid solution, to increase the rate of coalescence, if needed. Once a circularity of about 0.98 was achieved, the mixture was passed through a heat exchanger to quickly lower the temperature below the T_{g} of the toner. The toner particles were collected by filtration, washed, and dried using typical methods. Following isolation of the toner particles, the D50 was 7.50 μm, the circularity was 0.985, and the T_{g} (mid) was 51.4° C. Rheological properties were as follows: G′=591 Pa and G″=1467 Pa at 120° C.; and G′=351 Pa and G″=807 Pa at 140° C.

Comparative Example 1—Toner Synthesis: Toner synthesis using metal salt coagulant. Toner particles were prepared using an emulsion aggregation-coalescence process as follows. Core polyester latex, pigment, waxes, and deionized water were mixed in a reactor. The pH was adjusted to 4.2 using aqueous nitric acid solution. Aqueous Al₂(SO₄)₃ solution was added and the obtained slurry was homogenized. The mixture was heated at 45-50° C. for aggregation. Particle size (D50) was monitored, and at a D50 of about 5 (micrometers) μm, a negatively-charged polyester shell latex was added to the mixture using a metered pump until a D50 of about 6.1 to 6.3 μm was reached. The same shell latex as in Examples 3 and 4 was used. The aggregation step was quenched by addition of aqueous sodium hydroxide solution and a chelating agent to increase the pH to about 8.3-8.5. The mixture was then heated at 85° C. for coalescence. Aqueous sodium hydroxide solution was slowly added to the slurry during ramp-up to maintain the pH at ˜7.8-8.2. The mixture was held at the coalescence temperature and the circularity was monitored. The pH was lowered by the addition of an acid, such as aqueous nitric acid solution, to increase the rate of coalescence, if needed. Once a circularity of about 0.97 was achieved, the mixture was passed through a heat exchanger to quickly lower the temperature below the T_{g} of the toner. The toner particles were collected by filtration, washed, and dried using typical methods. Following isolation of the toner particles, the D50 was 5.64 μm, the circularity was 0.972, and the T_{g} (mid) was 49.9° C. Rheological properties were as follows: G′=1198 Pa and G″=2646 Pa at 120° C.; and G′=430 Pa and G″=872 Pa at 140° C.

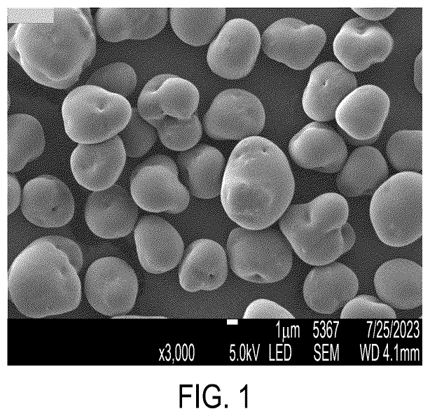

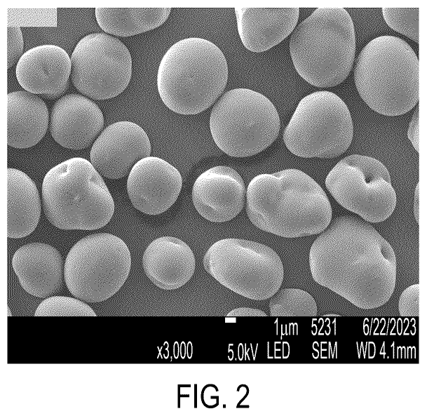

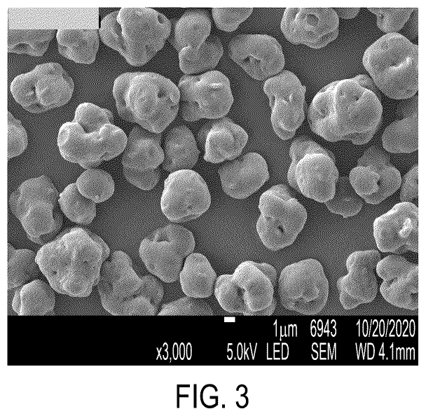

FIGS. 1 and 2 are SEM images of toner particles synthesized using water-soluble organic polymer coagulant 1 (Example 3) and water-soluble organic polymer coagulant 2 (Example 4), respectively. FIG. 3 is an SEM image of toner particles synthesized using a metal salt coagulant (Comparative Example 1). As shown, the morphology of the toner particles prepared using water-soluble organic polymer coagulants were similar and may be described as having a potato-shaped structure, which is akin to the morphology produced using metal salts as coagulants. Under the tested conditions, the toner particles produced using an organic polymer coagulant (Examples 3 and 4) were slightly larger and exhibited smoother surfaces (less surface area) than those coagulated with a metal salt (Comparative Example 1). Characterization data of the toner particles is summarized in Tables 1 and 2 below.

TABLE 1

| | Surface Area | | |
|---|---|---|---|
| | Multi-point | Single-point | |
| | N₂ surface | N₂ surface | Metals |
| | area | area | Al |
| Samples | (m²/g) | (m²/g) | (ug/g) |
| Example 3 | 0.953 | 0.844 | 0 |
| Example 4 | 0.779 | 0.678 | 0 |
| Comparative | 1.91 | 1.62 | 74 |
| Example 1 | | | |

TABLE 2

| | T_{g} | Tₛ | T_{fb} | T_{1/2} |
|---|---|---|---|---|
| Samples | (° C.) | (° C.) | (° C.) | (° C.) |
| Example 3 | 51.4 | 59.7 | 76.3 | 99.8 |
| Example 4 | 51.4 | 58.1 | 76.3 | 99.8 |
| Comparative | 49.9 | 60.6 | 73.9 | 96.5 |
| Example 1 | | | | |

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that we also contemplate the same composition or group of elements with transitional phrases “consisting essentially of,” “consisting of,” “selected from the group consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is:

1. A method comprising:
providing an aqueous slurry comprising a plurality of polymer particles comprising a first polymer having a first ionic charge, a water-soluble organic polymer coagulant having a second ionic charge opposite to the first ionic charge, and optionally, one or more internal additives;
maintaining the aqueous slurry at a first temperature below the glass transition temperature (T_{g}) of the polymer particles until aggregated polymer particles having a desired aggregate size have formed;
once aggregated polymer particles having the desired aggregate size have formed, heating the aqueous slurry at a second temperature above the T_{g};
maintaining the aqueous slurry above the T_{g} until the aggregated polymer particles have coalesced into molten toner particles having a desired shape and/or morphology; and
once molten toner particles having the desired shape and/or morphology have formed, cooling the aqueous slurry at a third temperature below the T_{g} to form solidified toner particles.

2. The method of claim 1, further comprising:
combining a second polymer with the aqueous slurry once the aggregated polymer particles having the desired aggregate size have formed, the second polymer forming a shell upon the aggregated polymer particles.

3. The method of claim 1, further comprising:
establishing an alkaline pH value in the aqueous slurry prior to or while heating the aqueous slurry at the second temperature.

4. The method of claim 3, wherein the alkaline pH value is maintained while maintaining the aqueous slurry above the T_{g}.

5. The method of claim 3, further comprising:
adding an aqueous acid to the aqueous slurry while maintaining the aqueous slurry above the T_{g} to lower pH while still maintaining an alkaline pH value.

6. The method of claim 1, wherein the polymer particles comprise at least one first polymer selected from the group consisting of polyesters, polystyrenes, polyacrylates, any copolymer thereof, and any combination thereof.

7. The method of claim 1, wherein the water-soluble organic polymer coagulant comprises an acrylate or methacrylate polymer or copolymer.

8. The method of claim 1, wherein the water-soluble organic polymer coagulant has a positive charge and the polymer particles have a negative charge.

9. The method of claim 1, wherein the water-soluble organic polymer coagulant comprises one or more monomers having the first ionic charge and one or more nonionic monomers.

10. The method of claim 9, wherein the one or more monomers having the first ionic charge is present in a greater molar amount than the one or more nonionic monomers.

11. The method of claim 1, wherein a metal salt coagulant and/or a chelating agent is/are not present when forming the aggregated polymer particles.

12. The method of claim 1, wherein the aqueous slurry comprises about 0.1 wt % to about 1 wt % of the water-soluble organic polymer coagulant, based on total mass of the solidified toner particles.

13. The method of claim 1, wherein the one or more internal additives are present and comprise at least one additive selected from the group consisting of colorants, waxes, charge transfer agents, and any combination thereof.

14. The method of claim 1, further comprising:
isolating the solidified toner particles; and
optionally, blending one or more external additives with the solidified toner particles.

15. A toner composition comprising:
toner particles comprising one or more first polymers having a first ionic charge, and optionally, one or more internal additives within the toner particles; and
optionally, one or more external additives blended with the toner particles;
wherein the toner particles are substantially free of a metal salt coagulant, an inorganic coating, inorganic nanoparticles, a chelating agent, or any combination thereof.

16. The toner composition of claim 15, wherein the toner particles further comprise a water-soluble organic polymer coagulant having a second ionic charge opposite to the first ionic charge.

17. The toner composition of claim 15, wherein the toner particles comprise at least one first polymer selected from the group consisting of polyesters, polystyrenes, polyacrylates, any copolymer thereof, and any combination thereof.

18. The toner composition of claim 15, wherein the one or more internal additives and/or the one or more external additives, if present, comprise at least one additive selected from the group consisting of colorants, waxes, charge transfer agents, and any combination thereof.

19. The toner composition of claim 15, wherein the toner particles comprise core-shell toner particles, the core-shell toner particles comprising a core comprising the at least one first polymer and a shell comprising a second polymer.

20. The toner composition of claim 15, wherein the toner particles have a D50 of about 5 μm to about 8 μm, a circularity of about 0.98 to about 1.00, and/or a surface area of about 0.6 m²/g to about 1.0 m²/g.
